(19) United States
(12) Patent Application Publication
(10) Pub. No.: US 2009/0325060 A1
(43) Pub. Date: Dec. 31, 2009

(54) CAR BATTERY ARRAY

(76) Inventors: Tsuyoshi KOMAKI, Kasai City (JP); Atsushi Fujita, Kasai City (JP)

Correspondence Address: WENDEROTH, LIND & PONACK, L.L.P., 1030 15th Street, N.W.,, Suite 400 East, Washington, DC, 20005-1503, US

(21) Appl. No.: 12/489,677

(22) Filed: Jun. 23, 2009

(30) Foreign Application Priority Data
Jun. 27, 2008 (JP) 2008-169342

(51) Int. Cl. H01M 6/42

(52) U.S. Cl. 429/160

(57) ABSTRACT

The car battery array is provided with a pair of end-plates 4 disposed in parallel orientation and with through-holes 41 established to expose battery 1 electrode terminals 6, a plurality of batteries 1 disposed between the end-plates 4 arranged in parallel orientation and perpendicular to the end-plates 4, and bus-bars 5 that connect battery 1 electrode terminals 6 exposed outside the end-plates 4 via the through-holes 41 to electrically connect adjacent batteries 1. Bus-bars 5 are curved to form center projections that protrude from bus-bar 5 midsections towards the outside of the end-plates 4. The center projections establish wire lead 7 cross-under openings 8 between the bus-bars 5 and the outer surfaces of the end-plates 4, and wire leads 7 that connect with the batteries 1 are inserted through those cross-under openings 8.

### BACKGROUND OF THE INVENTION

1. Field of the Invention

The present invention relates to a car battery array that is installed in a car to supply electric power to a motor that drives the car.

2. Description of the Related Art

A car battery array has many batteries connected in series to increase output voltage. This serves to increase the electric power supplied to the motor. A structure that disposes many batteries in fixed positions has been developed and is cited in Japanese Patent Application Disclosure 2007-234369. This structure joins a plurality of batteries in straight-line configurations as battery modules, and disposes many battery modules in parallel orientation between a pair of end-plates.

A car battery array with the structure described in this disclosure is shown in FIG. 1. In this battery array, electrode terminals 96 at the ends of the battery modules 91 are exposed to the outside by through-holes in the end-plates 94. Electrode terminals 96 of adjacent battery modules 91 are connected by bus-bars 95 disposed outside the end-plates 94. Both ends of the bus-bars 95 are attached to battery module 91 terminals 96 to connect adjacent battery modules 91 in series. As shown by the broken lines of the figure, wire leads 97 are disposed outside the end-plates 94 of this battery array structure. FIG. 2 shows a circuit diagram of the battery array. The battery array of this figure has a positive-side battery unit 90 and negative-side battery unit 90 connected in series by a safety plug 99 at the center. The safety plug 99 is disconnected to cut-off output voltage during operations such as maintenance work. As shown by the broken lines of FIG. 1, a battery array with this circuit configuration has three wire leads 97 disposed on the surface of the end-plates 94. The upper-most first lead 97A is an output lead, and the pair of leads 97B, 97C disposed near the middle and at the bottom is the pair of leads connected to the safety plug 99. To reduce the height that the leads project out from the surface of the end-plates 94, the three wire leads 97 are disposed in regions where there are no bus-bars 95. In the battery array of FIG. 1, two wire leads 97A, 97C are disposed along the upper and lower edges of the end-plates 94, and one wire lead 97B is disposed between the upper and lower rows of bus-bars 95.

Since the output lead 97A of the battery array shown in FIG. 1 is disposed along the upper edge of the end-plates 94, the output lead 97A is disposed in close proximity to the rest of the car when the battery array is installed in a car. The output lead carries pulses of high current and radiates large amounts of noise. When the output lead is disposed in proximity to the car chassis, it has the drawback that noise is induced in the chassis and the overall noise level of the car is raised. Noise induced in the chassis can be reduced by lowering the output lead from the upper edge of the end-plates. However, if the large diameter output lead is moved from the upper edge to a lower position, it must be positioned with separation from the end-plates and this has the drawback that outline dimensions of the battery array are increased.

Meanwhile, when the bus-bars are shaped as flat metal plates with both ends attached to battery module electrode terminals, it is difficult to absorb differences in battery dimensions. This drawback can be eliminated by bending bus-bar midsections into curved surfaces. This is because the curved region of a bus-bar can deform easily to absorb dimensional differences. However, if curved bus-bars are attached to the electrode terminals, the amount of bus-bar protrusion from the end-plates increases. Consequently, if a large diameter output lead is now disposed on a surface of curved bus-bars, it has the drawback that outline dimensions of the battery array are further increased.

The present invention was developed with the object of correcting the drawbacks described above. Thus, it is a primary object of the present invention to provide a car battery array that can absorb differences in battery dimensions via bus-bars, reduce battery array outline dimensions by disposing wire leads between the bus-bars and end-plates in regions established by the bus-bars, and lower noise levels induced by the car chassis.

### SUMMARY OF THE INVENTION

The car battery array of the present invention is provided with a pair of end-plates 4 disposed in parallel orientation and having through-holes 41 to expose battery 1 electrode terminals 6, a plurality of batteries 1 disposed between the end-plates 4 in parallel orientation perpendicular to the end-plates 4, and bus-bars 5 connected to battery 1 electrode terminals 6 exposed outside the end-plates 4 by the through-holes 41 to electrically connect adjacent batteries 1. Each bus-bar 5 is curved at its midsection to have a center projection that protrudes out from the end-plates 4. This creates cross-under openings 8 for routing wire leads 7 between the bus-bars 5 and the outer surface of the end-plate 4. Wire leads 7 that connect with the batteries 1 are routed through those cross-under openings 8.

In the car battery array described above, wire leads are routed between the bus-bars and end-plate while battery dimension differences are absorbed by the bus-bars. Therefore, the battery array has the characteristics that its outline dimensions can be reduced by routing wire leads through openings established by the bus-bars, and noise levels induced in the car chassis can be reduced.

In the car battery array of the present invention, batteries 1 are disposed between end-plates 4 in a plurality of rows and columns, and adjacent bus-bars 5 are arranged in parallel orientation. Wire leads 7 can be routed through the cross-under openings 8 established by the parallel array of a plurality of bus-bars 5. Since wire leads 7 are routed through the cross-under openings 8 of a plurality of bus-bars 5, this battery array has the characteristic that wire leads 7 can be disposed in a stable fashion in fixed positions on the end-plates 4.

In the car battery array of the present invention, a plurality of battery cells 1A can be joined in straight-line configurations as battery modules to arrange the batteries 1 disposed between the end-plates 4.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view of a prior art car battery array;

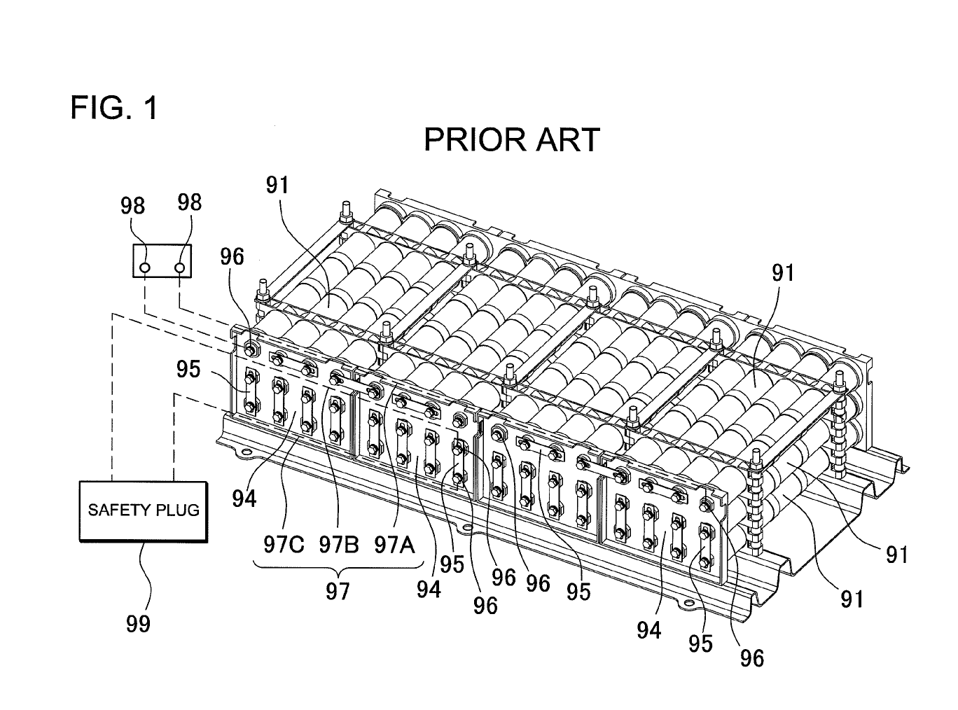

FIG. 2 is a circuit diagram for the car battery array shown in FIG. 1;

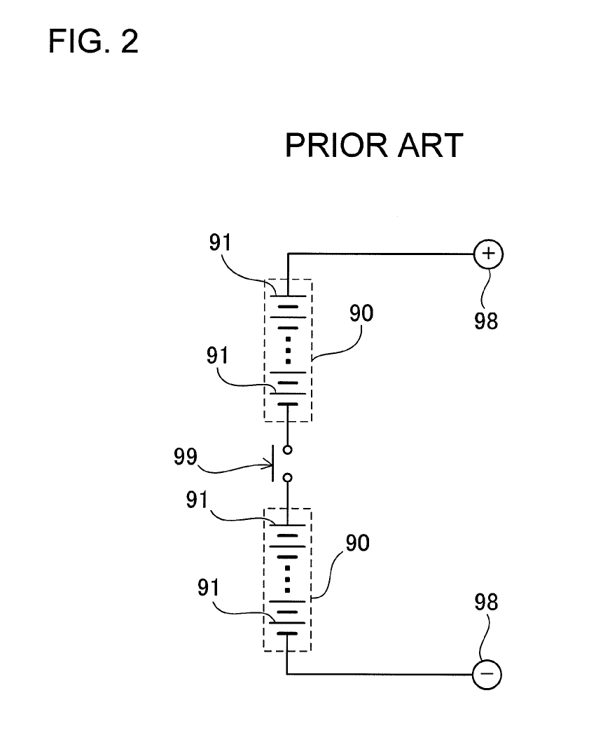

FIG. 3 is an abbreviated perspective view of a car battery array for one embodiment of the present invention;

FIG. 4 is a perspective view of the car battery array shown in FIG. 3 with the upper case removed;

FIG. 5 is a lateral cross-section view of the car battery array shown in FIG. 3;

FIG. 6 is an enlarged lateral cross-section view showing important parts of the car battery array shown in FIG. 3;

FIG. 7 is a lengthwise cross-section view of a car battery array for an embodiment of the present invention; and

FIG. 8 is a circuit diagram of a car battery array for an embodiment of the present invention.

### DETAILED DESCRIPTION OF THE PREFERRED EMBODIMENT(S)

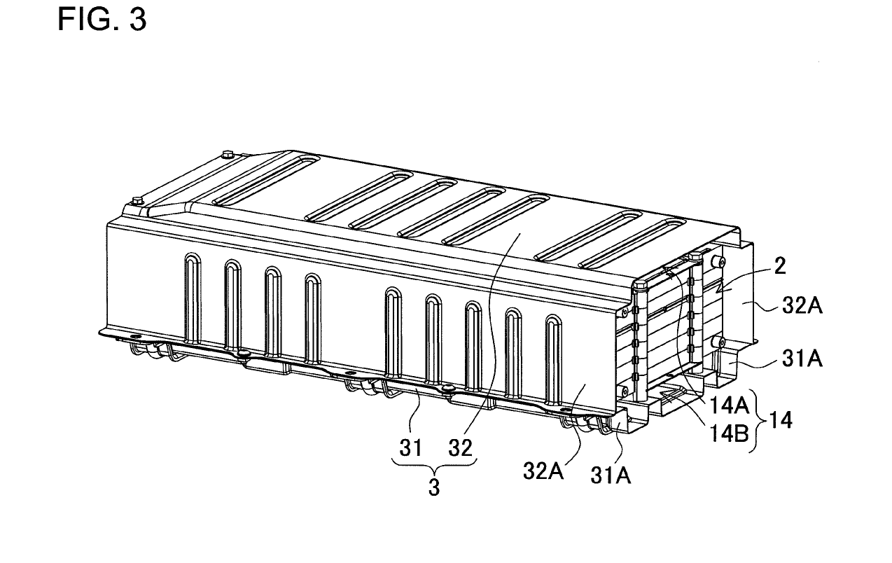

The car battery array shown in FIGS. 3-8 is provided with a pair of end-plates 4 disposed in parallel orientation, a plurality of batteries 1 disposed between the end-plates 4 in parallel orientation perpendicular to the end-plates 4, and bus-bars 5 connected to battery 1 electrode terminals 6 outside the end-plates 4 to electrically connect adjacent batteries 1.

The battery array of the figures has a plurality of batteries 1 arranged vertically and horizontally in parallel orientation and held in fixed positions in a plastic battery holder 2. The battery array shown in FIGS. 3, 5, and 7 is provided with an external case 3 that houses the battery holder 2, and cooling ducts 14 are established between the battery holder 2 and the external case 3.

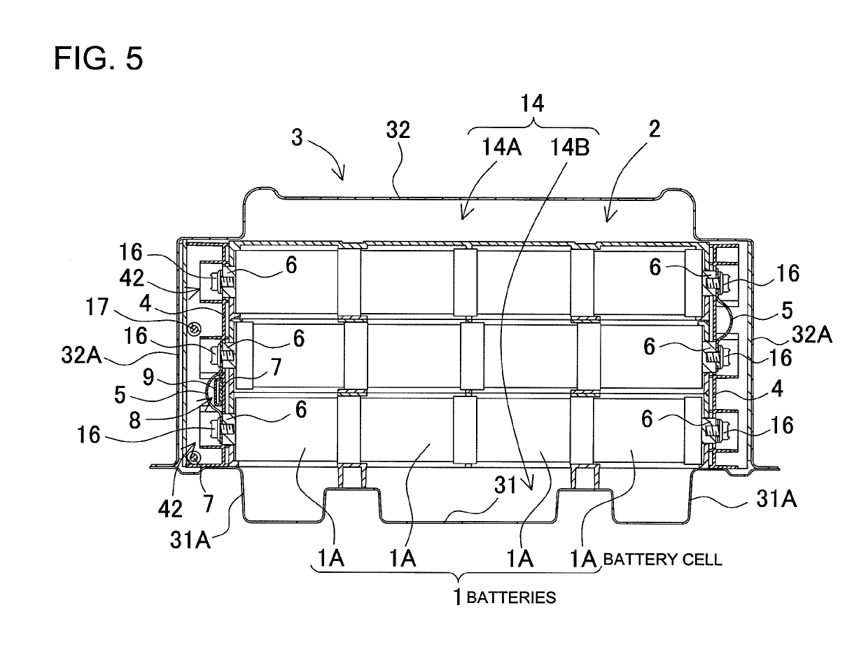

Any batteries 1 that can be recharged, such as nickel hydride batteries or lithium ion batteries can be used. The batteries 1 of FIG. 5 have four battery cells 1A joined in straight-line units with electrode terminals 6 fixed at both ends to allow bus-bar 5 connection. Although not illustrated, batteries can also be arranged as single batteries 1, or as battery modules with a plurality of three battery cells or less or five battery cells or more joined in straight-line configurations.

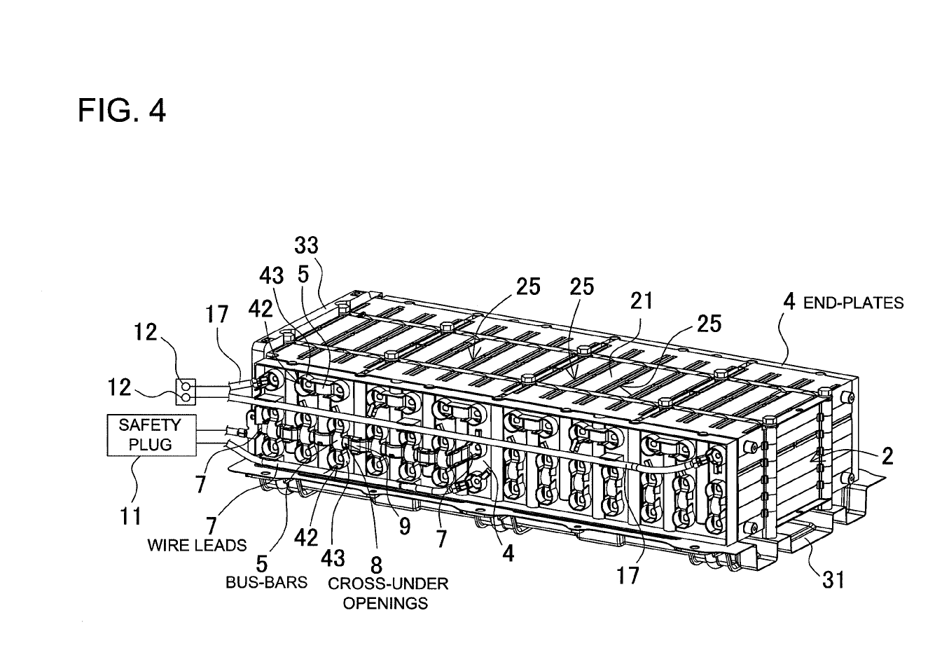

The end-plates 4 are connected to the battery holder 2 and dispose the batteries 1 in fixed positions. In addition, the end-plates 4 are provided with guide rims 42 to hold the bus-bars 5 in fixed positions. The bus-bars 5 connect with the electrode terminals 6 of the batteries 1. The end-plates 4 of FIG. 4 are made of insulating plastic and guide rim ribs 43 are formed as a single piece with the end-plates 4 around the perimeters of the guide rims 42. Through-holes 41 that expose electrode terminals 6 outside the end-plates 4 are provided inside the guide rims 42. Electrode terminals 6 are exposed through the through-holes 41 and bus-bars 5 are attached to the electrode terminals 6 via bolts 16.

Both ends of the bus-bars 5 are connected to electrode terminals 6 exposed outside the end-plates 4 via the through-holes 41 to connect adjacent batteries 1 in series. Although bus-bars 5 of the battery array shown in the figures connects batteries 1 in series, bus-bars can also connect adjacent batteries in series and in parallel. As shown in the cross-section of FIG. 5, bus-bars 5 are attached to electrode terminals 6 via bolts 16, which pass through the bus-bars 5 and thread into mating holes in the electrode terminals 6.

Bus-bars 5 are conductive metal plates bent at the midsection to curve to center projections that protrude out from the end-plates 4. Both ends of the bus-bars 5 are attached to electrode terminals 6 via bolts 16. A bus-bar 5 with a curved center projection can absorb differences in the dimensions of adjacent batteries 1. This is because a bus-bar with a curved region can deform more easily than a flat metal plate. Differences in battery 1 dimensions arise during battery manufacture. In particular, dimension differences for battery modules, which have a plurality of battery cells joined in straight-line configurations, can be large because of the cumulative effect of dimension differences for the individual battery cells. For batteries 1 having different length dimensions, electrode terminals 6, which connect with bus-bars 5 via bolts 16, do not line up in the same plane and are disposed at different levels. Since bus-bars 5 pass high currents, thick metal plates are used. If thick, difficult to deform flat metal plates are fixed to adjacent electrode terminals of batteries with different length dimensions, battery electrode terminals are forced to deform applying detrimental force on the batteries. A bus-bar 5 with a curved center projection has a long overall length and the curved region is more easily deformed. Consequently, when a curved bus-bar 5 is attached to electrode terminals 6 at different levels, the curved region deforms to absorb the level difference. As a result, detrimental force on the batteries can be prevented.

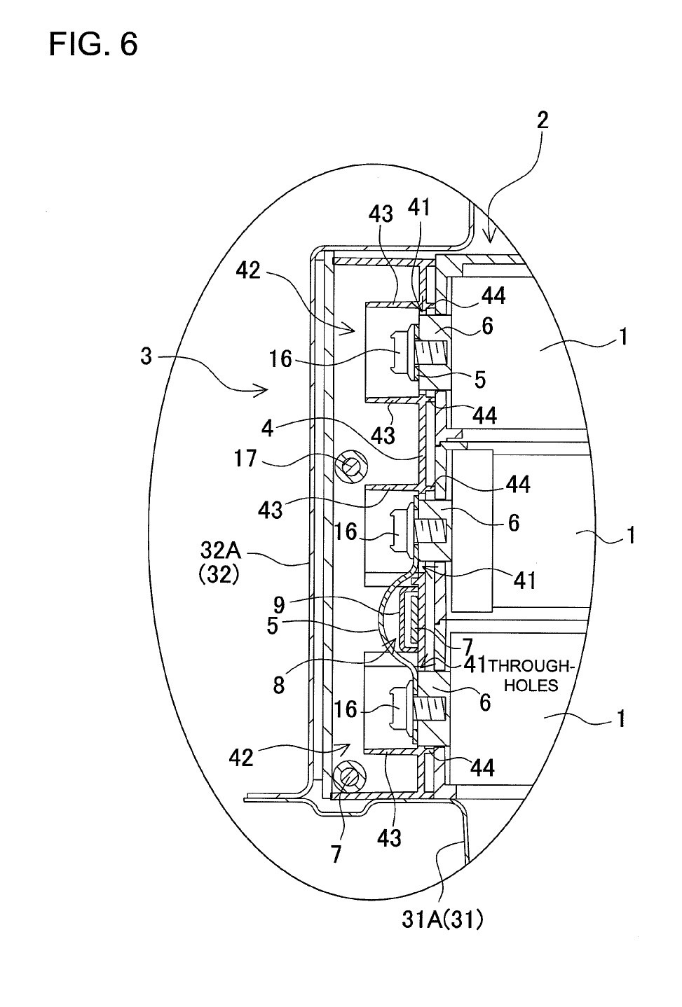

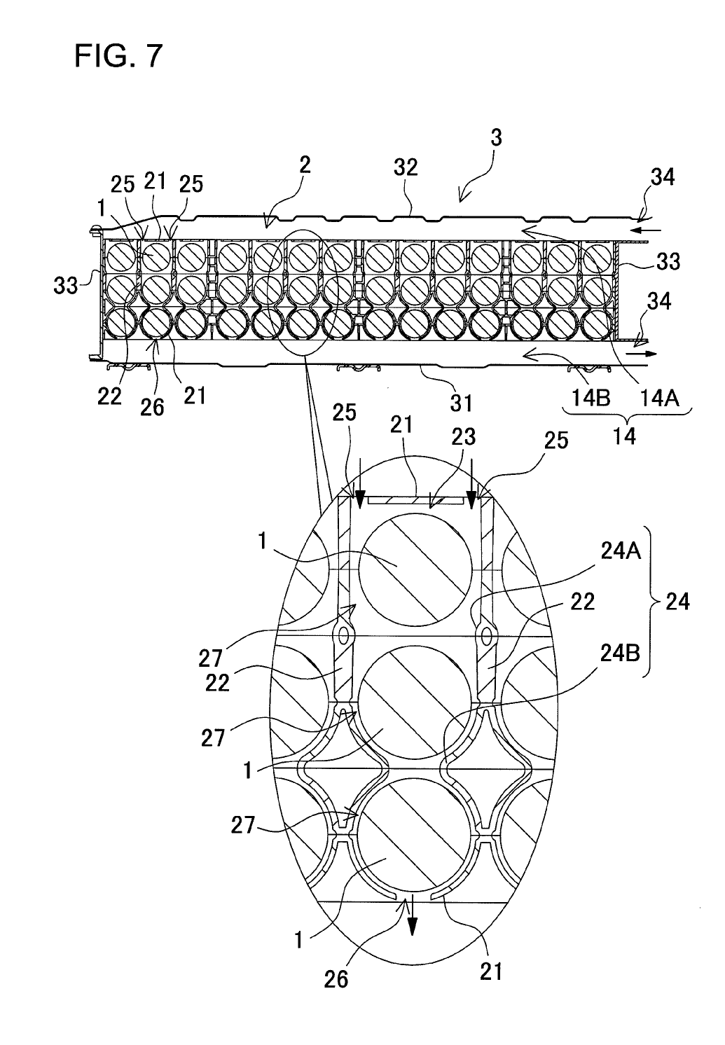

As shown in FIGS. 4-6, bus-bars 5 with curved center projections establish cross-under openings 8 between the bus-bars 5 and end-plate 4 outer surfaces to route wire leads 7. These cross-under openings 8 are used effectively by inserting wire leads 7 connected to the batteries 1. Batteries 1 are disposed between end-plates 4 in a plurality of rows and columns, and are disposed in 3 rows and 14 columns in FIGS. 4 and 7. Bus-bars 5 that connect batteries 1 in the upper row are oriented extending in the lengthwise direction of the end-plates 4 (in the horizontal direction of the figures). Bus-bars 5 that connect batteries 1 in the middle and lower rows are oriented parallel and extending in the lateral direction of the end-plates 4 (in the vertical direction of the figures). A wire lead 7 is inserted through cross-under openings 8 between the end-plate 4 and the plurality of bus-bars 5 disposed in the lateral direction. As shown in the enlarged cross-section of FIG. 6, the surface of the wire lead 7 is insulated to electrically isolate the wire lead 7 and the bus-bars 5. The wire lead 7 of this figure is provided with rail-shaped insulating material 9 on the wire lead 7 surface opposite the bus-bars 5. The metal plate wire lead 7 is insulated by insertion inside the rail-shaped insulating material 9. As shown in FIG. 4, a configuration that inserts a wire lead 7 through cross-under openings 8 inside a plurality of columns of bus-bars 5, which intersect with the path of the wire lead 7, allows the wire lead 7 to be retained by the plurality of bus-bars 5 without shifting position.

In the battery array of FIG. 4, a wire lead 7 is routed through cross-under openings 8 inside the bus-bars 5, and the wire lead 7 extends in the lengthwise direction of the end-plates 4. The wire lead 7 routed through the cross-under openings 8 connects with a safety plug 11. In the battery array of FIG. 4, electrode terminals 6 in the upper row of the figure are connected to output terminals 12, and battery array center region electrode terminals 6 in the middle and lower rows are connected to the safety plug 11. An output lead 17 connected to the electrode terminal 6 at the upper right end of FIG. 4 is connected to an output terminal 12 and is routed between the electrode terminals 6 of the upper and middle rows. The wire lead 7 connected to electrode terminals 6 in the middle row is routed through the cross-under openings 8 between the bus-bars 5 and the end-plate 4. The wire lead 7 connected to electrode terminals 6 in the lower row is routed along the lower edge of the end-plate 4. In this battery array, an output lead 17 is also connected to the electrode terminal 6 at the upper left end of the end-plates 4, and the pair of output leads 17 is connected to contactors (not illustrated). The wire lead 7 routed through the cross-under openings 8 and the wire lead 7 routed along the lower edge of the end-plate 4 are connected to the safety plug 11.

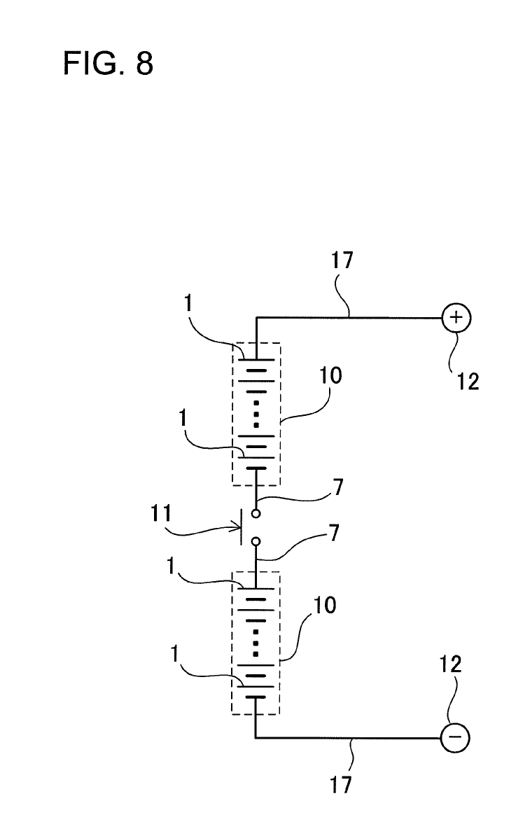

The circuit diagram for this battery array is shown in FIG. 8. In this battery array, the safety plug 11 is connected via wire leads 7 between a positive-side battery unit 10 and a negative-side battery unit 10. Further, the positive and negative outputs of the battery units 10, which are connected in series via the safety plug 11, are connected to output terminals 12 via output leads 17. As shown in FIGS. 4-6, one wire lead 7 connected to the safety plug 11 is routed through cross-under openings 8 between the bus-bars 5 and end-plate 4, and the other wire lead 7 is routed along the lower edge of the end-plate 4. One of the output leads 17 is routed along the surface of the end-plate 4 between the upper and middle rows.

In the battery array described above, a high current wire lead 7 that connects directly with the batteries 1 is inserted through the cross-under openings 8 established between the bus-bars 5 and end-plate 4. However, the present invention does not limit the wire leads inserted through cross-under openings to high current leads directly connected with the batteries. For example, leads that connect indirectly with the batteries, such as leads that detect battery voltage, current, or temperature, can also be routed through the cross-under openings.

Further, as shown in the enlarged cross-section of FIG. 6, end-plates 4 are provided with battery-end retainer regions 44 that project from the inner surfaces of the end-plates 4 to hold electrode terminals 6. Battery-end retainer regions 44 have cylindrical shapes that allows insertion of battery 1 end regions, and the electrode terminals 6 of batteries 1 held in the battery holder 2 are inserted into those battery-end retainer regions 44. The batteries 1 shown in FIG. 6 are provided with electrode terminals 6 at both ends that have a smaller diameter than the battery 1 itself, and those electrode terminals 6 are inserted into battery-end retainer regions 44 to hold the batteries 1 in fixed positions.

The external case 3 is made of metal. As shown in FIGS. 3-5, and 7, the external case 3 is made up of a bottom case 31, a top case 32 that connects with the bottom case 31 on both sides, and end panels 33 that close off the open regions at both ends of the top case 32 and bottom case 31. The bottom case 31 is sheet metal formed to a shape that has side walls 31A on both sides. As shown in the cross-section of FIG. 5, the bottom case 31 is formed in a trough shape to allow cooling ducts 14 to be established below the battery holder 2. Similarly, the top case 32 is sheet metal formed to a shape that covers the top and both sides of the battery holder 2 and also allows cooling ducts 14 to be established above the battery holder 2. The bottom edges of the side walls 32A on both sides of the top case 32 are attached to both sides of the bottom case 31 by fasteners such as set screws. In the battery array of FIG. 7, the right end of the external case 3 is closed off by an end panel 33, and that end panel 33 is provided with connecting ducts 34 that join with the cooling ducts 14. Forced ventilation of cooling air takes place through the connecting ducts 34. Further, as shown in FIGS. 3 and 7, the left end of the external case 3 is closed off by another end panel 33.

In the battery array of FIGS. 5 and 7, intake-side cooling ducts 14A are provided on the top side of the battery holder 2 and exhaust-side cooling ducts 14B are provided on the bottom side of the battery holder 2. In this battery array, battery 1 cooling fluid such as cooling air flows from the intake-side cooling ducts 14A into the interior of the battery holder 2, and is discharged to the outside from the exhaust-side cooling ducts 14B. Cooling fluid passes through cooling channels 27 established between battery 1 surfaces and opposing walls 22 provided in the battery holder 2 to cool the batteries 1. The fluid that flows through the cooling channels 27 is air. However, the fluid that flows through the cooling channels 27 can also be a gas or liquid other than air.

The battery holder 2 has end-plates 4 attached at both ends. The battery holder 2 is formed from plastic as a single piece. As shown in the cross-section of FIG. 7, the battery holder 2 is provided with a plurality of parallel disposed opposing walls 22 inside outer walls 21, and with battery I storage areas 23 to hold a plurality of batteries 1 between the opposing walls 22. The battery holder 2 is provided cooling channels 27 to pass battery 1 cooling air between the opposing walls 22 and the batteries 1. Further, opposing walls 22 are provided with projections 24 that protrude from both sides into depressions created between adjacent batteries 1. The projections 24 put the inside surfaces of opposing walls 22 in close proximity with battery 1 surfaces and narrow the cooling channels 27 between the batteries 1 and the inside surfaces of the opposing walls 22. In addition, in the battery holder 2 of FIG. 7, the heights of the projections 24 that protrude into the depressions between batteries 1 increase down-stream from the cooling air intake towards the exhaust. Tall projections 24 narrow the cooling channels disposed at the battery 1 surfaces to increase cooling fluid flow rate. As a result, a battery holder 2 with this configuration can uniformly cool batteries 1 both up-stream and down-stream. This is because even when cooling fluid temperature increases down-stream, effective cooling is accomplished with a high flow rate. In particular, by forming down-stream projections 24 in shapes that closely follow the battery 1 surfaces, forced air cooling at a high flow rate can be accomplished over a large area of the downstream batteries 1 to allow effective cooling.

In the battery holder 2 of FIG. 7, since three rows of batteries 1 are held between opposing walls 22, two projections 24 are provided on both sides of the opposing walls 22 to establish two regions where the walls protrude inwards. The opposing walls 22 of the figure are provided with first projections 24A at the boundary between the first row and second row of batteries 1, and with second projections 24B between the second row and third row of batteries 1. The projection height of the down-stream second projections 24B is greater than that of the up-stream first projections 24A, and the surfaces of the down-stream projections second 24B are shaped to conform with the battery 1 surfaces.

As shown in the cross-section of FIG. 7, the battery holder 2 is provided with intake openings 25 and exhaust openings 26 to enable the flow of battery 1 cooling fluid such as cooling air. Intake openings 25 and exhaust openings 26 are shaped as slits that extend in the lengthwise direction of the batteries 1 for forced ventilation over the entire length of the batteries 1. Intake openings 25 are established at both sides of each battery 1 storage area 23, and an exhaust opening 26 is established at the center region of each storage area 23. In this battery holder 2, air is introduced into each battery 1 storage area through intake openings 25 established on both sides, air ventilates both sides of the batteries 1 flowing from top to bottom in FIG. 7, and air flows out the exhaust opening 26 for discharge outside the battery holder 2. Consequently, this battery array is cooled by forced air ventilation via the following flow: intake-side cooling ducts 14A→intake openings 25→cooling channels 27→exhaust openings 26→exhaust-side cooling ducts 14B.

In the battery array described above, since three rows of batteries 1 are held between a pair of opposing walls 22, projections 24 are established in two places along the pair of opposing walls 22. In a battery array storing two rows of batteries between opposing walls, projections can be established in one place along the pair of opposing walls. Further, in the battery array of the present invention, a configuration storing four or more batteries between a pair of opposing walls can have projections in one to three or more places along the pair of opposing walls.

Further, the battery holder 2 is provided with retaining projections (not illustrated) formed as a single piece with the battery holder 2 to hold the inserted batteries 1 in fixed positions. In this battery holder 2, since batteries 1 are held in place by the battery holder 2 and both end regions of the batteries 1 are retained in fixed positions by the end-plates 4, each battery 1 can be accurately positioned.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2008-169,342 filed in Japan on Jun. 27, 2008, the content of which is incorporated herein by reference.

What is claimed is:

1. A car battery array comprising:
a pair of end-plates disposed in parallel orientation and provided with through-holes to expose battery electrode terminals;
a plurality of batteries disposed between the end-plates arranged in parallel orientation and perpendicular to the end-plates; and
bus-bars that connect battery electrode terminals exposed outside the end-plates via the through-holes to electrically connect adjacent batteries;
wherein bus-bars have center projections that protrude from bus-bar midsections towards the outside of the end-plates, the center projections establish wire lead cross-under openings between the bus-bars and the outer surfaces of the end-plates, and wire leads that connect with the batteries are inserted through those cross-under openings.

2. The car battery array as cited in claim 1 wherein the bus-bars are curved to form center projections.

3. The car battery array as cited in claim 1 wherein the end-plates have guide rims that dispose bus-bars in fixed positions, and guide rim ribs formed as a single piece with the end-plates are provided around the perimeter of the guide rims.

4. The car battery array as cited in claim 1 wherein both ends of the bus-bars are fixed to electrode terminals via bolts.

5. The car battery array as cited in claim 1 wherein bus-bars are conductive metal plates.

6. The car battery array as cited in claim 1 wherein the electrode terminals with bus-bars attached via bolts do not all lie in the same plane.

7. The car battery array as cited in claim 1 wherein batteries are disposed in a plurality rows and a plurality of columns between the end-plates, adjacent bus-bars are disposed in parallel orientation, and wire leads are inserted through the cross-under openings of a plurality of bus-bars disposed in parallel orientation.

8. The car battery array as cited in claim 1 wherein wire leads that pass through cross-under openings inside the bus-bars are routed to extend in the lengthwise direction of the end-plates.

9. The car battery array as cited in claim 1 wherein the surfaces of the wire leads are insulated and the wire leads are disposed in cross-under openings.

10. The car battery array as cited in claim 8 wherein rail-shaped insulating material is provided between wire leads and opposing bus-bar surfaces, and the wire leads are inserted into the rail grooves of the insulating material.

11. The car battery array as cited in claim 10 wherein wire leads that are metal plates are disposed in the rail grooves of the insulating material.

12. The car battery array as cited in claim 1 wherein wire leads inserted through cross-under openings connect to a safety plug.

13. The car battery array as cited in claim 1 wherein the wire leads inserted through cross-under openings established between bus-bars and end-plates are high current wire leads directly connected to batteries.

14. The car battery array as cited in claim 1 wherein the batteries disposed between the end-plates are battery modules having a plurality of battery cells joined in straight-line fashion.
